(19) United States
(12) Patent Application Publication
(10) Pub. No.: US 2002/0113864 A1
(43) Pub. Date: Aug. 22, 2002

(54) A STEROCAMERA FOR DIGITAL PHOTOGRAMMETRY

(76) Inventors: ANKO BORNER, BERLIN (DE); RALF REULKE, WILDAU (DE)

Correspondence Address: THOMAS C PONTANI, COHEN PONTANI LIEBERMAN & PAVANE, 551 FIFTH AVENUE, SUITE 1210, NEW YORK, NY, 10176

(21) Appl. No.: 09/242,266

(22) PCT Filed: Aug. 14, 1997
(86) PCT No.: PCT/EP97/04443

(30) Foreign Application Priority Data
Aug. 16, 1996 (DE) 196 33 868.9

(51) Int. Cl. H04N 13/02

(52) U.S. Cl. 348/42

(57) ABSTRACT

The invention relates to a stereo camera (1) for digital photogrammetry, comprising an input optical system (2) and optical detectors which are arranged in the focal plane (3) and whose output signals are processed in an evaluation device (6) to form image information, in which device from a multiplicity of optical detectors in the focal plane (3) in each case at least two of the optical detectors can be driven together as a function of advance information, stored in a storage medium, from the object to be photographed in order to set a desired stereo angle.

The invention relates to a stereo camera for photogrammetry in accordance with the preamble of patent claim 1.

Cameras with conventional filters are currently still being used to produce terrain profiles for maps. The data of the film taken are subsequently digitized and converted into a terrain profile using known evaluation methods of photography.

Digital photogrammetry constitutes a substantial advance over classical photographs. The fundamentals of this are provided, on the one hand, by high-resolution digital image pick-up devices and, on the other hand, by high-precision position sensors and locators such as, for example, differential GPSs or fiber gyros. The classic film is replaced in this case by optical detectors such as, for example, CCD components. The advantage of digital photogrammetry resides in the fact that the recorded data are present at once in digital form and not firstly digitized, and this leads to a substantial time saving. Determining contour values of a point of terrain under observation requires at least two photographs of the area from different positions. This can be implemented by multiple overflights of an area or by using a plurality of camera systems and producing overlapping images.

The specialist article entitled “Dynamische Photogrammetrie; Zeitschrift für Photogrammetrie und Fernerkundung, Bildmessung und Luftbildwesen [“Dynamic photogrammetry: Journal for photogrammetry and remote sensing, photogrammetry and aerial photogrammetry”], Otto Hofmann, 3/86 pages 105 ff” has disclosed a stereo camera which has three CCD rows and by means of which a terrain can be recorded in the case of only one overflight by using the proper motion of the aircraft or satellite carrying the stereo camera. The basic principle is to use three CCD rows to take overlapping picture records of a terrain point from different perspectives. In order, on the one hand, to achieve a higher numerical stability in calculating the contour values and, on the other hand, to prevent a highly structured terrain from being invisible for specific rows, at least three CCD rows are generally used instead of only the two CCD rows theoretically required.

For this purpose, three CCD rows are arranged parallel to one another at equidistant spacings in a focal plane situated at a spacing f from the main point of the input optical system. Owing to the fact that the input optical system is offset once in a positive and once in a negative direction relative to the main axis, one CCD row looks forward, one downward and the third backward. The angle which is described by the focal length and the spacing between the CCD rows is the stereo angle α. Homologous image points of the three flight strips are then determined by area-wide correlation for the purpose of geometrical reconstruction of the strip model, these image points then being arranged approximately in the shape of a grid. The six outer orientation parameters of the stereo scanner are then determined at so-called imaging interpolation points at regular time intervals along the flight path, and the terrain coordinates of those points which are assigned to the correlated image points are determined. These stereo cameras have already been successfully used in the contribution to the DLR to the Mars 96 Mission WAOSS “Wide Angle Optoelectronic Stereo Scanner (WAOSS), Mars 94 Mission, Phase B Study, WAOSS Technical Part; Berlin 1991” and the successor model thereto WACC “Wide Angle Airborne Camera, OEPE Workshop, Digital Camera, IGN Paris 28.-29.9.1994, A. Eckardt”.

DE 42 13 281 has disclosed a stereo camera for photogrammetry which comprises an input optical system and a multiplicity of optical detectors which are arranged in the focal plane (camera image plane). In this case, at least three scanning rows are arranged unequally spaced from one another, with the result that a different stereo angle is set up in each case between two neighboring scanning rows. The result is a close sequence of interpolation points which can be combined with one another and by means of which it is possible to reach an accurate conclusion on the position of the stereo camera. For the purpose of setting desired, different stereo angles between the optical detectors, the latter are constructed to be capable of displacement in the focal plane, so that a desired preadjustment of the stereo angles can be undertaken before said detectors are put into use. The stereo angles set are then fixed during operation.

The previously described stereo angle α has a substantial influence on the quality of the terrain model to be produced, the optimum value of this parameter being a function of the terrain to be observed. No reliable investigations of the magnitude of the stereo angle α have yet been made. Since experimental investigations are too expensive or impossible, such optimization has been carried out by means of a simulation tool “Bömer, A: Simulation optoelektronischer Systeme [“Simulation of optoelectronic systems”]; Diploma thesis, Ilmenau 1995”. The essential results of this investigation can be summarized as follows:

stereo angles α of greater than 10° and less than 40° (wide-angle camera) should be selected in principle,

the optimum stereo angle α depends decisively on the contour dynamics of the area flown over, contour dynamics being understood as a change in the contour values of the area flown over. The stereo angle α does not play an important role for a flat area. By contrast, when the contour dynamics of the terrain are pronounced, the range of the permissible stereo angle α is substantially restricted, and this is true, in particular, in the case of overflying urban areas, for all simulated cases, a stereo angle α of between 15° and 20° offers optimum quality in the production of digital terrain models.

A disadvantage of the known stereo cameras for digital photogrammetry is that the stereo angle α is stipulated, and that as a result no account is taken of any changes in the terrain and/or in the photographing conditions. Thus, for example, the combination of forward-looking and rearward-looking CCD rows is unsuitable for stereo reconstruction in the case of highly elliptical orbits, because of the different range when photographing the same areas. In urban areas, as well, the recorded images are very strongly dependent on the observing angle, with the result that the recommended stereo angles a of 15° are already too large, making it necessary to work in the sub-optimum range.

EP-0 037 530 has disclosed a stereo camera for photogrammetry which comprises an input optical system and at least two row-shaped optical detectors which are arranged in the focal plane. In order to set different stereo angles, the optical detectors are arranged capable of being displaced in the focal plane, with the result that a different stereo angle can be preadjusted by a change in the spacing of the row-shaped optical detectors. The set stereo angle remains unchanged during operation of the stereo camera. If different stereo angles are optionally required, a multiplicity of optical detectors are arranged fixed in the focal plane, and the optical detectors respectively required for the desired stereo angle are used to record the image.

The invention is therefore based on the technical problem of creating a stereo camera by means of which it is possible to achieve a constant photographic quality for a variously structured terrain, with as few image data as possible.

The problem is solved by means of the features of patent claim 1. The assignment of a storage medium in which there is stored advance information, on an object to be photographed, as a function of which the respective stereo angle of the optical detectors is selected to adapt the stereo angle at any time to the conditions of the terrain, thus achieving optimum accuracy in surveying. Further advantageous refinements of the invention follow from the subclaims.

In addition, this advance information can also be recorded directly by the stereo camera by means of a suitable device.

The optional drive can be implemented simply and reliably by the arrangement of a multiplexer between the optical detectors and the evaluation device. Moreover, the multiplexer can easily be co-integrated if required in the case of the use of a monolithic CCD matrix. The object to be surveyed can also be determined in different spectral regions by the use of spectral filter layers or microlenses.

The invention is explained in more detail below with the aid of a preferred exemplary embodiment. In the figures:

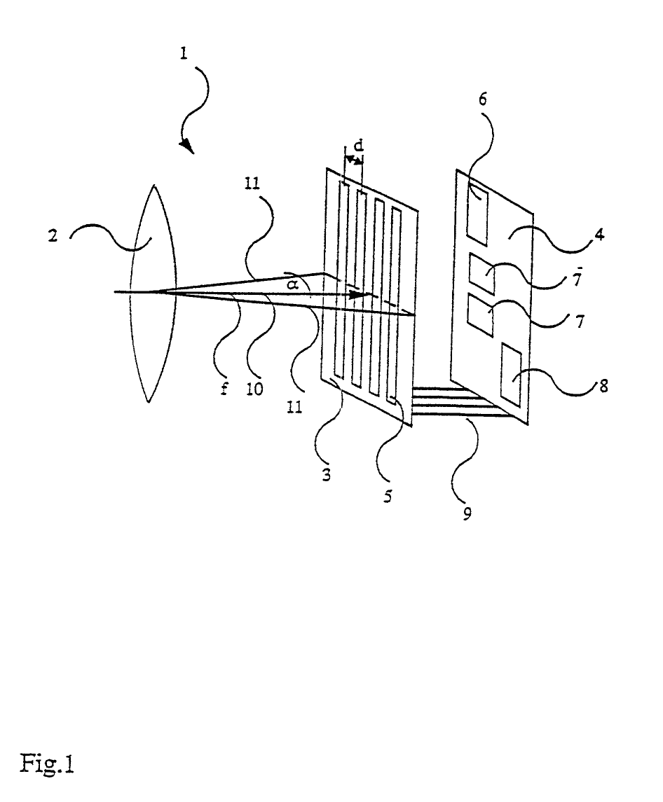

FIG. 1: shows a diagrammatic perspective view of the stereo camera, and

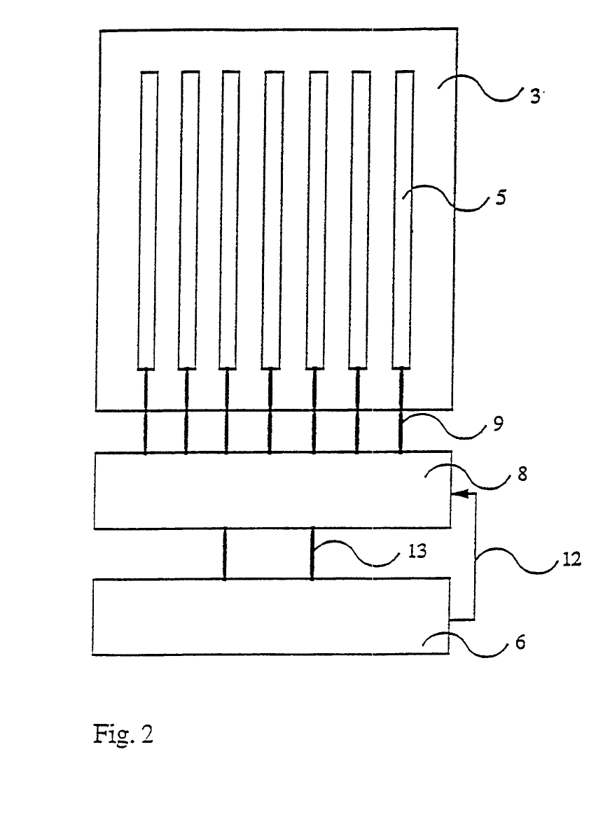

FIG. 2: shows a block diagram of the focal plane and the evaluation device.

The stereo camera 1 comprises an input optical system 2, a focal plane 3 and a printed circuit board 4. The focal plane 3 is arranged in the focal plane of the input optical system 2 at a spacing f. A plurality of CCD rows 5 are arranged in the focal plane 3 at equidistant spacings d.

The printed circuit board 4 comprises an evaluation device 6, a plurality of storage elements 7 and a multiplexer 8. The CCD rows 5 are connected to the multiplexer 8 via a database 9. The output of the multiplexer 8 is connected to the input of the evaluation device 6. In addition, the output of the multiplexer 8 can be connected to one of the storage elements 7. The data output of the evaluation device 6 is likewise connected to the input of the storage elements 7. In accordance with the advance information on the object to be photographed, the evaluation device 6 uses a further control signal to drive the multiplexer 8. This advance information on the object to be photographed is stored, for example, in a storage medium assigned to the evaluation device 6. The light emitted or reflected by an object to be observed impinges on the input optical system 2 and is projected by the input optical system 2 onto the focal plane 3, with the result that all the CCD rows 5 arranged in the focal plane 3 are irradiated. The angle formed by the main axis 10 and limb 11 is denoted as the stereo angle α. The stereo angle α can in this case assume values of between −40° and +40°. The respective data of a CCD row 5 are connected via the bus 9 to the data input of the multiplexer 8, the evaluation device 6 being used to drive the multiplexer 8 in such a way that only the data of specific CCD rows 5 is switched through to the evaluation device 6. If the stereo camera 1 is overflying, for example, flat terrain such a desert, the two outer CCD rows 5 are switched through. If the stereo camera 1 now suddenly overflies a terrain with more pronounced contour dynamics such as, for example, a mountain range or a town, the evaluation device 6 changes its control signal to the multiplexer 8, with the result that a CCD row 5 with a smaller stereo angle a is now respectively switched through. The respective optimum stereo angle a can now be selected by suitable control loops. If required, it is also possible to select CCD rows 5 of differing stereo angles α, such as, for example, in the case of observing from elliptical orbits.

A block diagram of the focal plane 3 and the evaluation device 6 is represented in FIG. 2. The data of each CCD row 5 are connected to the data input of the multiplexer 8 via the database 9. The evaluation device 6 uses a control line 12 to select two CCD rows 5 whose data are fed via a data line 13 to the input of the evaluation device 6 and processed further there.

1. A stereo camera for digital photogrammetry, comprising an input optical system and a multiplicity of optical detectors which are arranged in the focal plane of the input optical system and whose output signals can be processed to form image information in an evaluation device, it being the case that at least two of the optical detectors can in each case optionally be driven to set a variable stereo angle, wherein the stereo camera (1) is assigned a storage medium in which advance information on an object to be photographed is stored, and the stereo angle of the optical detectors can be set as a function of the advance information from the object to be photographed.

2. The stereo camera as claimed in claim 1, wherein the stereo camera (1) comprises a device for recording the advance information on the object subsequently to be photographed.

3. The stereo camera as claimed in claim 1 or 2, wherein the optical detectors are constructed as a CCD matrix or CCD rows (5) which are applied to a carrier using hybrid technology.

4. The stereo camera as claimed in one of the preceding claims, wherein a multiplexer (8) is arranged for optionally driving between the optical detectors and the evaluation device (6).

5. The stereo camera as claimed in one of the preceding claims, wherein the neighboring optical detectors are provided with different spectral filter layers or microlenses.

6. The stereo camera as claimed in one of the preceding claims, wherein the stereo angle α between the main axis (10) and a limb (11) of an optical detector is between −40° and +40°.
